(19) United States
(12) Patent Application Publication
(10) Pub. No.: US 2020/0152992 A1
(43) Pub. Date: May 14, 2020

(54) ELECTRODE FOR SOLID STATE BATTERY, SOLID STATE BATTERY AND MANUFACTURING METHOD OF ELECTRODE FOR SOLID STATE BATTERY

(71) Applicant: Honda Motor Co.,Ltd., Tokyo (JP)

(72) Inventors: Wataru SHIMIZU, Saitama (JP); Ushio HARADA, Saitama (JP); Hiroto MAEYAMA, Saitama (JP); Atsushi OGAWA, Saitama (JP); Soshi KAWAMURA, Saitama (JP); Masahiro OHTA, Saitama (JP)

(73) Assignee: Honda Motor Co.,Ltd., Tokyo (JP)

(21) Appl. No.: 16/676,459

(22) Filed: Nov. 7, 2019

(30) Foreign Application Priority Data
Nov. 8, 2018 (JP) 2018-210689

(51) Int. Cl. H01M 4/80; H01M 10/0585; H01M 4/62; H01M 4/36; H01M 4/66

(52) U.S. Cl. CPC H01M 4/808; H01M 10/0585; H01M 2004/021; H01M 4/362; H01M 4/661; H01M 4/622

(57) ABSTRACT

The disclosure provides an electrode for solid state battery, a solid state battery, and a manufacturing method of the electrode for solid state battery. The electrode for solid state battery uses a foamed porous body as the collector. When the electrode constitutes the solid state battery, the obtained battery has low resistance, high battery capacity per unit area, and high output. A collector composed of a foamed porous body is filled with an electrode mixture by differential pressure filling to obtain an electrode, in which the content rate of an organic polymer compound is low.

### CROSS REFERENCE TO RELATED APPLICATION

This application claims the priority benefit of Japan Application No. 2018-210689, filed on Nov. 8, 2018. The entirety of the above-mentioned patent application is hereby incorporated by reference herein and made a part of this specification.

### BACKGROUND

### Technical Field

The disclosure relates to an electrode for solid state battery, a solid state battery, and a manufacturing method of the electrode for solid state battery.

### Description of Related Art

Lithium ion secondary batteries have been widely used as secondary batteries having high energy density. A lithium ion secondary battery has a structure which includes a separator between the positive electrode and the negative electrode and is filled with a liquid electrolyte (electrolytic solution).

Here, since the electrolytic solution of the lithium ion secondary battery is usually a flammable organic solvent, the safety against heat in particular may be a problem. Therefore, a lithium ion solid state battery using an inorganic solid electrolyte instead of an organic liquid electrolyte has been proposed (see Patent Document 1).

The lithium ion solid state battery has a structure in which a solid electrolyte layer is disposed between a positive electrode layer and a negative electrode layer. Usually, the positive electrode layer and the negative electrode layer are formed by supporting an electrode mixture, which contains electrode active material powder, solid electrolyte powder, and a conductive aid added as required, on a metal foil or the like that serves as a collector. In order to increase the capacity of the lithium ion solid state battery, it is necessary to contain a large amount of electrode active material in the electrode layer.

Here, the electrode layer may be thickened, as a method of containing a large amount of electrode active material in the electrode layer. By thickening the electrode layer, the amount of electrode active material per unit area can be increased. As a method of thickening the electrode layer, for example, slurry of an electrode mixture that contains a binder or thickener composed of an organic polymer compound may be applied thickly on a metal foil using a wet process. However, if the electrode layer is thickened, cracking of the electrode layer due to bulk fracture or peeling of the electrode layer from the metal foil is likely to occur.

Therefore, a method has been proposed, which increases the amount of the binder or thickener added to the slurry to enhance the bondability between the materials that constitute the electrode mixture or the bondability between the mixture and the collector foil. However, since the organic polymer compound remains in the electrode even after drying, it causes deterioration of the battery characteristics.

FIG. 1 is an enlarged cross-sectional view of an electrode that achieves the bondability using a binder or thickener composed of an organic polymer compound. As shown in FIG. 1, for example, when the organic polymer compound is present in the negative electrode layer, the organic polymer compound 3 covers the surface of the electrode active material 2 or the solid electrolyte 1, and the electrode active material 2 and the solid electrolyte 1 are in contact via the organic polymer compound 3.

In addition, when the organic polymer compound is segregated, the area of contact between the electrode active material and the solid electrolyte via the organic polymer compound that is present at the interface is increased. In such a case, the organic polymer compound is present not only between the materials used in the electrode mixture but also between the electrode mixture and the collector, and the electrode mixture and the collector are in contact via the organic polymer compound.

That is, when the electrode layer is formed using a binder or thickener composed of an organic polymer compound, it has merits that the organic polymer compound can secure the viscosity of the slurry, facilitate coating of a thick film, and improve the adhesion between the electrode active material, the solid electrolyte, other components, and the collector, but on the other hand, it has a demerit that the resistance increases.

In addition, in order to increase the capacity of a solid state battery, it has been proposed to use a collector having a thin mesh structure as the collector that constitutes the positive electrode layer and the negative electrode layer. By filling the electrode mixture into the mesh structure, the amount of active material per unit area of the electrode layer can be increased to increase the capacity of the battery.

A foamed metal, for example, may serve as the collector having such a mesh structure. The foamed metal has advantages when used as the collector for it has uniform pore diameter and large surface area (see Patent Documents 2 and 3).

Since an electrode using a porous body containing a foamed metal as the collector is to hold the electrode mixture in the pores of the porous body, a slurry electrode mixture with viscosity added with a binder or thickener composed of an organic polymer compound is used. In this case, the organic polymer compound is also present not only between the materials used in the electrode mixture but also at the interface between the electrode mixture and the collector, and the electrode mixture and the collector are in contact via the organic polymer compound, as shown in FIG. 1. The organic polymer compound remains in the electrode even after drying, which causes deterioration of the battery characteristics.

Deposition of electrode materials on a collector foil by a dry process has been proposed as a method for manufacturing an electrode that does not contain a binder or thickener composed of an organic polymer compound. In the dry process, however, it is difficult to increase the film thickness with high uniformity. Therefore, it is difficult to obtain a high capacity battery.

Moreover, electrodeposition, spray pyrolysis deposition, etc. have been proposed as methods for manufacturing an electrode that does not contain a binder or thickener composed of an organic polymer compound by a wet process. However, electrodeposition and spray pyrolysis deposition are not industrial methods for they require time to increase the area and film thickness.

Furthermore, Patent Document 4 proposes an electrode in which a metal porous body is used as the collector and the pores of the metal porous body are filled with an electrode mixture that does not contain a binder. However, for the electrode described in Patent Document 4, one side of the metal porous body needs to be covered with a foil. Thus, in the drying process, gas accumulation occurs, and there are concerns over formation of non-uniform distribution of materials having different densities and a decrease in the volume energy density due to the increased volume of the foil part.

### RELATED ART

### Patent Documents

[Patent Document 1] Japanese Laid-Open No. 2000-106154
[Patent Document 2] Japanese Laid-Open No. 7-099058
[Patent Document 3] Japanese Laid-Open No. 8-329954
[Patent Document 4] Japanese Laid-Open No. 2013-105702

### SUMMARY

An electrode for solid state battery, comprising a collector composed of a conductive foamed porous body; and an electrode mixture filled in the collector, wherein the electrode mixture comprises at least an electrode active material, a solid electrolyte, and an organic polymer compound, and a content of the organic polymer compound is 1.5% by mass or less with respect to a whole of the electrode mixture after drying.

A solid state battery, comprising a positive electrode layer comprising a positive electrode active material, a negative electrode layer comprising a negative electrode active material, and a solid electrolyte layer positioned between the positive electrode layer and the negative electrode layer, wherein at least one of the positive electrode layer and the negative electrode layer is composed of the electrode for solid state battery.

A manufacturing method of the electrode for solid state battery comprising an electrode mixture filling process of filling the electrode mixture into the collector composed of the conductive foamed porous body by differential pressure filling.

### BRIEF DESCRIPTION OF THE DRAWINGS

FIG. 1 is an enlarged cross-sectional view of an electrode that is obtained using a binder or thickener composed of an organic polymer compound.

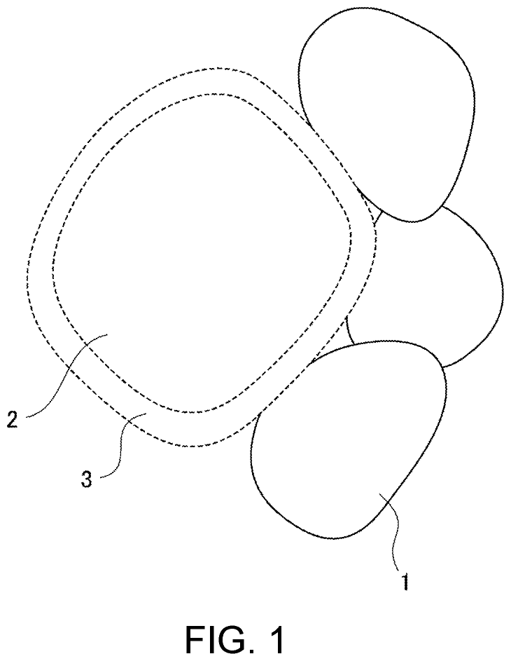

FIG. 2 is an enlarged cross-sectional view of an electrode for solid state battery according to the disclosure.

FIG. 3 is a diagram showing an embodiment of the electrode for solid state battery according to the disclosure.

FIG. 4(a) to FIG. 4(d) are diagrams showing an embodiment of a manufacturing method of the electrode for solid state battery according to the disclosure.

### DESCRIPTION OF THE EMBODIMENTS

Hereinafter, embodiments of the disclosure will be described with reference to the drawings.

### <Electrode for Solid State Battery>

An electrode for solid state battery of the disclosure includes a collector composed of a conductive foamed porous body, and an electrode mixture filled in the collector. The electrode mixture is characterized in containing at least an electrode active material, a solid electrolyte, and an organic polymer compound, and the content of the organic polymer compound is 1.5% by mass or less with respect to the whole of the electrode mixture.

The electrode for solid state battery of the disclosure can be used without any problem when applied as the positive electrode, the negative electrode, or both in a solid state battery.

### [Electrode Mixture]

In the disclosure, the electrode mixture filled in the collector of the foamed porous body contains at least an electrode active material, a solid electrolyte, and an organic polymer compound. The electrode mixture that can be used in the disclosure may optionally contain other components if it contains the electrode active material, the solid electrolyte, and the organic polymer compound. The other components are not particularly limited as long as they can be used for manufacturing a solid state battery.

In the case of the electrode mixture that constitutes the positive electrode, the electrode mixture contains at least a positive electrode active material, a solid electrolyte, and an organic polymer compound and may contain a conductive aid, a binder and the like, for example, as other components. The positive electrode active material is not particularly limited as long as it can occlude and release lithium ions, and may be LiCoO₂, LiCoO₄, LiMn₂O₄, LiNiO₂, LiFePO₄, lithium sulfide, sulfur, etc., for example.

In the case of the electrode mixture that constitutes the negative electrode, the electrode mixture contains at least a negative electrode active material, a solid electrolyte, and an organic polymer compound and may contain a conductive aid, a binder and the like, for example, as other components. The negative electrode active material is not particularly limited as long as it can occlude and release lithium ions, and may be metal lithium, lithium alloy, metal oxide, metal sulfide, metal nitride, silicon oxide, silicon, a carbon material such as graphite, etc., for example.

### (Organic Polymer Compound)

The organic polymer compound is included in the electrode mixture of the disclosure and is filled into the collector of the foamed porous body to constitute an electrode layer. The organic polymer compound serves as a binder or thickener, and usually ensures the viscosity of the electrode mixture slurry and improves the adhesion between the electrode active material and the solid electrolyte.

### {Type}

The organic polymer compound used in the disclosure is not particularly limited to a certain type and may be any compound that can be used as a binder for binding the electrode active material, the solid electrolyte, and other components included in the electrode mixture with each other, or binding the components included in the electrode mixture and the collector of the foamed porous body with each other when forming the electrode mixture layer. The organic polymer compound may be an acrylic acid polymer, a cellulose polymer, a styrene polymer, a vinyl acetate polymer, a urethane polymer, a fluoroethylene polymer, etc., for example. Among these, the acrylic acid polymer and styrene butadiene polymer are from the perspectives that they do not cause a decrease in capacity of the electrode active material or a decrease in lithium ion conductivity of the solid electrolyte and are uniformly dispersed in a low polarity solvent that can lower the water content.

### {Content}

The content of the organic polymer compound is 1.5% by mass or less with respect to the whole of the electrode mixture after drying. The content is more preferably 1.0% by mass or less, and particularly preferably 0.5% by mass or less. When the content is 1.5% by mass or less, the binding of the electrode active material, the solid electrolyte, other components, and the collector of the foamed porous body is sufficiently strong, and the resistance of the obtained electrode is sufficiently low.

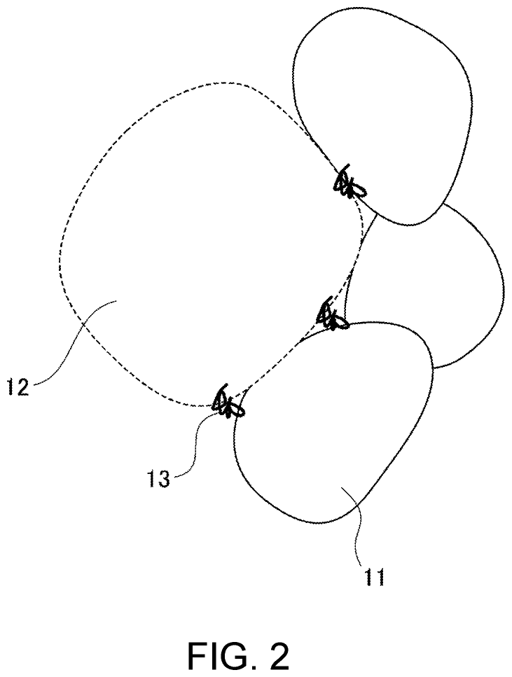

An enlarged cross-sectional view of the electrode for solid state battery of the disclosure is shown in FIG. 2. The electrode for solid state battery of the disclosure has a point binding part where the organic polymer compound 13 is present at a point at the interface between the electrode active material 12 and the solid electrolyte 11, and the electrode active material 12 and the solid electrolyte 11 are bonded by the point binding part. In the disclosure, the resistance of the obtained electrode can be reduced by the point binding part where the organic polymer compound is present at a point.

### {Point Binding Part}

The size of the point binding part is preferably in the range of 1 nm to 500 nm. The size is more preferably in the range of 30 nm to 300 nm, and particularly preferably in the range of 50 nm to 100 nm. The electrode active material, the solid electrolyte, and other components contained in the electrode mixture, or the components contained in the electrode mixture and the collector of the foamed porous body are bonded to each other in the point region of 1 nm to 500 nm, which makes it possible to increase the region where the electrode active material, the solid electrolyte, other components, and the collector of the foamed porous body are in direct contact without the organic polymer compound.

### [Collector]

The collector used in the electrode for solid state battery of the disclosure is a conductive foamed porous body. The conductive foamed porous body is not particularly limited as long as it is a porous body obtained by foaming a conductive material. By using the conductive foamed porous body as the collector, it is easy to fix the electrode mixture so the thickness of the electrode layer can be increased without thickening the coating slurry of the electrode mixture. In addition, since the binder composed of an organic polymer compound, which is necessary for thickening, can be reduced, it can contribute to high capacity while keeping the resistance low when the solid state battery is constituted.

The surface of the collector used in the electrode for solid state battery of the disclosure may be processed by a surface treatment in order to improve the bondability between the electrode mixture filled in the foamed porous body and the foamed porous body. The surface treatment may be coating with a carbon material such as graphite, chemical modification with hydrochloric acid, oxalic acid, ammonia, etc., for example.

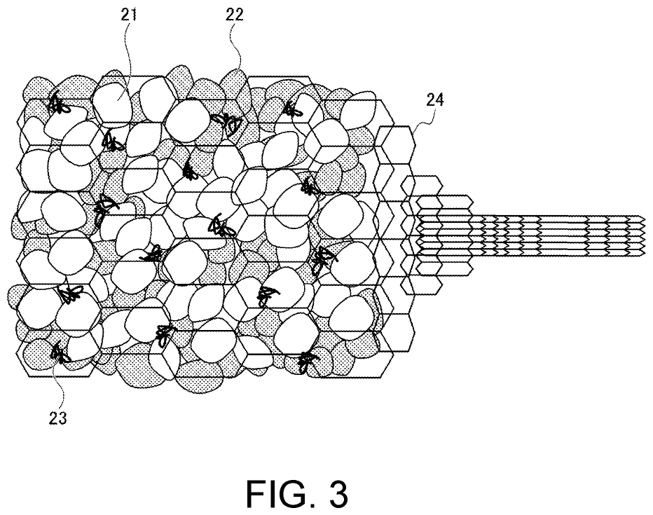

An embodiment of the electrode for solid state battery of the disclosure is shown in FIG. 3. In the electrode for solid state battery according to an embodiment of the disclosure, the electrode active material 22, the solid electrolyte 21, and the organic polymer compound 23 are filled into the pores of the mesh structure of the collector 24 composed of the conductive foamed porous body in a state where the organic polymer compound 23 forms the point binding part at the interface between the electrode active material 22 and the solid electrolyte 21.

The collector used in the electrode for solid state battery of the disclosure is a foamed porous body of a metal, that is, a foamed metal. The metal may be nickel, aluminum, stainless steel, titanium, copper, silver, etc., for example.

Since the foamed metal has a three-dimensional mesh structure, it can improve the current collection performance and the retention performance for the active material as compared with other conventional collectors. Therefore, as compared with using a metal foil as a collector, the thickness of the mixture layer can be increased without an increase in resistance, and as a result, the capacity per unit area of the electrode can be increased. In addition, for example, since the porosity of the foamed metal is higher than that of a metal fiber sintered body, the filling amount of the active material can be increased, and as a result, the capacity of the electrode can be increased.

### <Manufacturing Method of Electrode for Solid State Battery>

A manufacturing method of the electrode for solid state battery of the disclosure is not particularly limited, and an ordinary method in the technical field can be applied, in which it includes an electrode mixture filling process of filling the electrode mixture into the collector composed of a conductive foamed porous body by differential pressure filling.

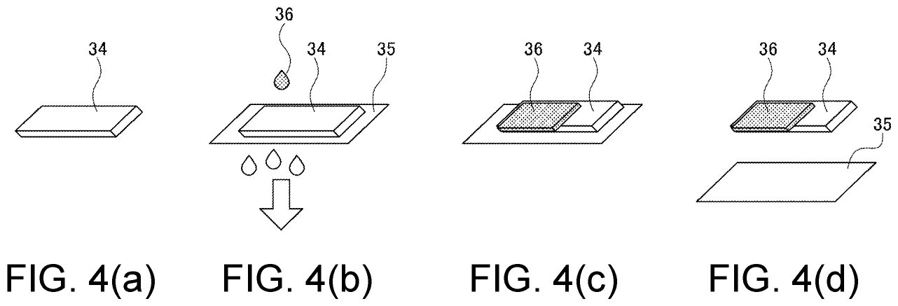

FIG. 4(a) to FIG. 4(d) show an embodiment of the manufacturing method of the electrode for solid state battery according to the disclosure. In the method shown in FIG. 4(a) to FIG. 4(d), first, a collector 34 is prepared (FIG. 4(a)). Next, a filter 35 is disposed under the collector 34, and an electrode mixture 36 is filled into the surface of the collector 34 where the filter 35 is not present while being sucked from the outside of the side where the filter 35 is present (FIG. 4(b)).

Subsequently, the collector 34 filled with the electrode mixture 36 is dried and pressed to improve the density of the electrode mixture (FIG. 4(c)). Thereafter, the filter 35 is peeled off from the collector 34 to obtain the electrode for solid state battery (FIG. 4(d)).

### [Differential Pressure Filling Process]

The differential pressure filling process in the manufacturing method of the electrode for solid state battery of the disclosure is shown in FIG. 4(b) in an embodiment shown in FIG. 4(a) to FIG. 4(d). The differential pressure filling process of the disclosure is a process of creating a pressure difference between the surface, to which the electrode mixture is injected, and the back surface of the collector, and permeating the electrode mixture into the collector through the pores that form the mesh structure of the collector by the pressure difference.

In order to increase the filling amount of the electrode active material, it is required to fill the electrode mixture throughout the pores of the mesh structure. Therefore, the differential pressure filling process is preferably performed to a level that the electrode mixture reaches the surface opposite to the surface, to which the electrode mixture is injected, through the pores of the collector and then is filtered.

The method of creating the pressure difference between the surface, to which the electrode mixture is injected, and the back surface is not particularly limited and may be a method of reducing the pressure on the surface opposite to the surface, to which the electrode mixture is injected, with a rotary pump or the like, a method of pressurizing the surface, to which the electrode mixture is injected, with a compressor or the like, a method of creating the pressure difference by a combination of both, etc., for example.

The properties of the electrode mixture injected in the differential pressure filling process are not particularly limited, and the electrode mixture may be obtained by a dry process using powder or obtained by a wet process using a mixture containing a liquid such as slurry.

In addition, other processes are not particularly limited as long as the manufacturing method of the electrode for solid state battery of the disclosure includes the above-mentioned differential pressure filling process. The conventional processes used for manufacturing an electrode for solid state battery can be performed.

### <Solid State Battery>

A solid state battery of the disclosure includes a positive electrode layer including a positive electrode active material, a negative electrode layer including a negative electrode active material, and a solid electrolyte layer positioned between the positive electrode layer and the negative electrode layer. In the solid state battery of the disclosure, at least one of the positive electrode layer and the negative electrode layer is the electrode for solid state battery of the disclosure described above.

In the solid state battery of the disclosure, the positive electrode layer may be the electrode for solid state battery of the disclosure or the negative electrode layer may be the electrode for solid state battery of the disclosure, or both may be the electrode for solid state battery of the disclosure.

### [Positive Electrode and Negative Electrode]

In the solid state battery of the disclosure, the positive electrode layer and the negative electrode layer that do not use the electrode for solid state battery of the disclosure are not particularly limited as long as they function as the positive electrode and the negative electrode of a lithium ion solid state battery.

The positive electrode and the negative electrode that constitute the solid state battery can constitute any battery by selecting two types of materials from the materials that can constitute the electrodes, comparing the charge/discharge potentials of two types of compounds, and using the compound showing a high potential in the positive electrode and the compound showing a low potential in the negative electrode.

### [Solid Electrolyte]

The solid electrolyte contained in the solid electrolyte layer used in the solid state battery of the disclosure is not particularly limited as long as it allows lithium ion conduction between the positive electrode and the negative electrode. For example, the solid electrolyte may be an oxide-based electrolyte or a sulfide-based electrolyte.

In view of the above background technology, the disclosure provides an electrode for solid state battery, a solid state battery, and a manufacturing method of the electrode for solid state battery. The electrode for solid state battery uses a foamed porous body as a collector. When the electrode constitutes a solid state battery, the obtained battery has low resistance, high battery capacity per unit area, and high output.

The inventors have intensively studied a method of filling an electrode mixture, in which the content rate of an organic polymer compound is low, in an electrode for solid state battery which uses a collector composed of a foamed porous body. As a result, the inventors found that if the electrode mixture is filled into the collector composed of a foamed porous body by differential pressure filling, an electrode with a low content rate of the organic polymer compound can be obtained, which led to completion of the disclosure.

That is, the disclosure provides an electrode for solid state battery, including: a collector composed of a conductive foamed porous body; and an electrode mixture filled in the collector, wherein the electrode mixture includes at least an electrode active material, a solid electrolyte, and an organic polymer compound, and a content of the organic polymer compound is 1.5% by mass or less with respect to a whole of the electrode mixture after drying.

The electrode for solid state battery may include a point binding part where the organic polymer compound is present at a point at an interface between the electrode active material and the solid electrolyte, and the electrode active material and the solid electrolyte may be bonded by the point binding part.

A size of the point binding part may be 1 nm to 100 nm.

The collector may be a foamed porous body of a metal.

The electrode for solid state battery may be a positive electrode.

The electrode for solid state battery may be a negative electrode.

The disclosure further provides a solid state battery, including: a positive electrode layer including a positive electrode active material; a negative electrode layer including a negative electrode active material; and a solid electrolyte layer positioned between the positive electrode layer and the negative electrode layer, wherein at least one of the positive electrode layer and the negative electrode layer is composed of the electrode for solid state battery mentioned above.

The disclosure further provides a manufacturing method of the electrode for solid state battery mentioned above. The manufacturing method including: an electrode mixture filling process of filling the electrode mixture into the collector composed of the conductive foamed porous body by differential pressure filling.

### Effects

According to the electrode for solid state battery of the disclosure, when the electrode constitutes a solid state battery, the obtained battery has low resistance, high battery capacity per unit area, and high output.

What is claimed is:

1. An electrode for solid state battery, comprising:
a collector composed of a conductive foamed porous body; and
an electrode mixture filled in the collector,
wherein the electrode mixture comprises at least an electrode active material, a solid electrolyte, and an organic polymer compound, and
a content of the organic polymer compound is 1.5% by mass or less with respect to a whole of the electrode mixture after drying.

2. The electrode for solid state battery according to claim 1, comprising a point binding part where the organic polymer compound is present at a point at an interface between the electrode active material and the solid electrolyte, wherein the electrode active material and the solid electrolyte are bonded by the point binding part.

3. The electrode for solid state battery according to claim 2, wherein a size of the point binding part is 1 nm to 100 nm.

4. The electrode for solid state battery according to claim 1, wherein the collector is a foamed porous body of a metal.

5. The electrode for solid state battery according to claim 1, wherein the electrode for solid state battery is a positive electrode.

6. The electrode for solid state battery according to claim 1, wherein the electrode for solid state battery is a negative electrode.

7. The electrode for solid state battery according to claim 2, wherein the collector is a foamed porous body of a metal.

8. The electrode for solid state battery according to claim 3, wherein the collector is a foamed porous body of a metal.

9. The electrode for solid state battery according to claim 2, wherein the electrode for solid state battery is a positive electrode.

10. The electrode for solid state battery according to claim 3, wherein the electrode for solid state battery is a positive electrode.

11. The electrode for solid state battery according to claim 4, wherein the electrode for solid state battery is a positive electrode.

12. The electrode for solid state battery according to claim 2, wherein the electrode for solid state battery is a negative electrode.

13. The electrode for solid state battery according to claim 3, wherein the electrode for solid state battery is a negative electrode.

14. The electrode for solid state battery according to claim 4, wherein the electrode for solid state battery is a negative electrode.

15. A solid state battery, comprising:
a positive electrode layer comprising a positive electrode active material;
a negative electrode layer comprising a negative electrode active material; and
a solid electrolyte layer positioned between the positive electrode layer and the negative electrode layer,
wherein at least one of the positive electrode layer and the negative electrode layer is composed of the electrode for solid state battery according to claim 1.

16. A manufacturing method of the electrode for solid state battery according to claim 1, the manufacturing method comprising:
an electrode mixture filling process of filling the electrode mixture into the collector composed of the conductive foamed porous body by differential pressure filling.
